(19) United States
(12) Patent Application Publication
(10) Pub. No.: US 2022/0040040 A1
(43) Pub. Date: Feb. 10, 2022

(54) VALVE WITH ON-OFF MECHANISM FOR BAG USED FOR CONDITIONING, RECONSTITUTING AND/OR DILUTING OF INJECTABLE PRODUCTS

(71) Applicant: Norival Caetano, Sao Paulo (BR)

(72) Inventor: Norival Caetano, Sao Paulo (BR)

(21) Appl. No.: 17/452,117

(22) Filed: Oct. 25, 2021

Related U.S. Application Data
(63) Continuation-in-part of application No. 16/317,467, filed on Jan. 11, 2019, now Pat. No. 11,154,456.

(30) Foreign Application Priority Data
Jul. 11, 2016 (BR) 1020160160160910
Jul. 6, 2017 (BR) PCT/BR2017/050183

(51) Int. Cl. A61J 1/20; F16K 21/00; A61J 1/10

(52) U.S. Cl. CPC A61J 1/2037; A61J 1/2096; A61J 1/10; F16K 21/00

(57) ABSTRACT

This CIP, Continuation-in-part, presents constructive details of the material contained in the original document BR 10 2016 016091-0 and not specified until then, and the valve (3) can also be used in transfers, dilution and drip chamber and medicine bottles, vaccines and related, the valve (3) has five basic components: conical base (4), which receives in its interior the assembly of the second component, which is the conical movable part (7); the conical base (4) which receives in its core (16) the assembly of the third component which is a smaller diameter o-ring sealing ring (13); on the other hand, the conical movable part (7) receives in its lower groove (14) the assembly of the fourth component, which is a larger diameter o-ring sealing ring (12); the conical base (4) receives the assembly of the fifth component which is the cap (10), which protects the thread in the luer-lock pattern (8); the cover (10) prevents the separation of the conical movable part (7) in relation to the conical base (4); the movable conical part (7) has a surface (22) with an angulation (X), equal to that verified on the inner surface (27) of the conical base (4); the constructive variation of the valve (3a) is fixed to the mouthpiece (6a) of the bottle (F) through its conical base (4), this adjusted to the diameter of the bottle, keeping the valve system unchanged; in addition, the cover (10) of the valve (3a) presents a constructive variation (not shown) formed by a cylindrical body, internally threaded, provided with a lower ring connected to the cover body through a plurality of breaking points, welding points plastic or shrink.

### APPLICATION FIELD

This document CIP, Continuation-in-part, presents and represents details and constructive variants of the material contained in the original document BR 10 2016 016091-0 and not specified until then.

The valve with on-off mechanism belongs to the pharmaceutical field, particularly in the area of human and animal health.

### PREAMBLE

The valve with on-off mechanism for bag used for conditioning, reconstituting and/or dilution of injectable products, besides using the valve with thread in the luer-lock pattern in plastic bags, this document provides details on the use of the valve in bottles of medicines, vaccines and the like, in addition to dilution and drip chambers, transfers replacing the usual perforable stoppers of rubber that makes up the bottle.

### OBJECTIVES OF THE INVENTION

The main object of this CIP, Continuation-in-part, is to present a new configuration for the valve with thread in luer-lock pattern that, despite being mentioned, was not detailed previously.

It is the use of this vale in bottles of medicines, vaccines and the like in addition to being used in parenteral bag as mentioned in the original document.

The valve as originally filed, is used as access to plastic bags that hold parenteral solutions (those administrable by injection) also in other medical devices, for example: dilution and drip chambers, transfers and vials containing drugs, vaccines and related, all devices to connect two other medical devices.

Another goal of this application is the presentation of a new closing alternative for this valve, as it was not presented in all its variants demanding at this time an alternative presentation of the closing caps of the cited valve.

The valve have an on-off mechanism for a bag used in packaging, reconstitution and/or dilution of products for injectable use it is a device for opening and closing access to a bag that now has a single functional door that is it functions as an entry or exit door and which can be subjected to numerous opening and closing cycles.

Said valve does not have membranes or stoppers to be pierced, and access to the interior of the bag is made through a luer-lock standard thread device, allowing its opening and closing with total safety.

### State of Art

The Holder of this application is a medical professional and has been researching the subject in question for many years and already has solutions filed with the competent intellectual property bodies, devices to avoid particles and reduce accidents by punctures and contaminations, such as the patent application of 29 Sep. 2010, PI 1003460-9, which had its Letter of Patent issued on Jun. 1, 2015.

Said patent entitled “BAG FOR PACKAGING, RECONSTITUTION AND/OR DILUTION OF INJECTABLE PRODUCTS” and incorporated several improvements, eliminating the inconveniences verified in the state of the art of the bags existing on the market at that time. This Letter-Patent innovated by proposing entrance and exit doors with on-off mechanism, alerting for the use of a particle retainer filter when it is necessary to attach a vial to a spike (plastic needle) at the entrance door, in addition to to incorporate standard luer-lock thread (luer-lock is the universal designation of a type of thread used in medical pharmaceutical devices) in the outlet port for access with standard luer-lock syringe or standard luer-lock infusion set, without use of needle or spike.

This device has eliminated the possibility of introducing particles from the membranes detached by perforation inside the bottle, as they are no longer necessary.

It became possible, then, to use a parenteral bag with a single exit door with on-off mechanism and luer-lock pattern thread, thus becoming a functional single-port bag without perforable membranes with access through a syringe with a luer-lock pattern thread (8 without the use of a metallic needle or an infusion set also in a luer-lock pattern without the use of a plastic spike.

The preparation of injectable products, particularly powders for injection, is performed by perforating the stopper of the vial containing the product, with a metallic needle, to add the liquid that will reconstitute the product, since only in liquid form can the product be administered parenterally/injectable.

Reconstituted the product, so that it is diluted in a bag, the transfer is made by perforating the membrane of the bag with a metal needle, in the so-called inlet port. To infuse this diluted product, another membrane of the bag is perforated with an infusion set equipped with a plastic spike/needle, in the so-called exit port.

Some dilution bags also come with plastic spikes/needles at the entrance port, so that the bottle can be attached to it and through the transfixation of the stopper by a plastic spike/needle. The outlet port of these bags is also equipped with a membrane to be perforated by an infusion set with a plastic spike/needle.

This is briefly how they are reconstituted or made liquid and diluted, when the concentration is reduced by adding more diluent, practically almost all injection powders on the market.

In addition to this request, in the continuation of the studies and researches of the Holder, with the intrinsic purpose of providing improvements with regard to the handling and safety of products for injectable use, it also has an application for the title, “VALVE WITH MECHANISM ON-OFF FOR BAG USED FOR PACKAGING, RECONSTITUTION AND/OR DILUTION OF PRODUCTS FOR INJECTABLE USE”, based on which this document CIP, Continuation-in-part is presented, referring to the valve formed by five elements: a tubular conical plastic base that it attaches to the plastic tube of the bag; a movable conical plastic piece that ends with a luer-lock pattern thread; two o-ring sealing rubber rings; a plastic cap that, in addition to protecting the luer-lock pattern thread, prevents the moving part from coming off the valve.

This valve allows the opening and closing to have a luer-lock pattern thread protected by a cap that will be opened only during use and, with the valve closed, even if a syringe with luer-lock thread pattern is attached to it or an infusion set also with a luer-lock pattern, the valve will only open with a traction movement, holding the syringe body or the chamber of the infusion set; after open, the opposite movement closes the valve.

### BRIEF DESCRIPTION OF THE INVENTION

The valve with on-off mechanism for bag used for packaging, reconstitution and/or dilution of products for injectable use, object of this CIP request, Continuation-in-part, is formed by five fundamental elements, namely, a tubular conical plastic base that attaches to the bag's plastic tube; a movable conical plastic piece that ends with a luer-lock pattern thread; two o-ring sealing rubber rings; a plastic cap that, in addition to protecting the luer-lock pattern thread, prevents the moving part from coming off the valve.

In addition to these components, in a constructive variant of this valve for use in vials of medicines, vaccines and the like, the conical base fails to provide for the narrowing defined by the tubular terminal (5), due to, in the use of the valve (3rd) in a bottle (F), there is no need for the canniculus (not illustrated).

The valve has a luer-lock pattern thread that is protected by a cap, which is only opened at the time of use.

If the valve is closed, even if a syringe with a luer-lock pattern thread or an infusion set also of a luer-lock pattern is attached to it, the valve will only open with a traction movement, holding in the syringe body or in the infusion set chamber; after open, the opposite movement closes the valve.

Thus, use a bag with the valve for preparing a product in a clean area and attach a syringe or an infusion set to the valve without opening the system; the valve will be opened, by the traction movement, only when the contents of the bag are actually used.

In the same way that, in the application of vaccines, whose vials always have more than one dose, there will be much more safety, practicality and speed in the transfer of the drug/vaccine from the vial to the syringe with luer-lock pattern thread.

Finally, this application also presents an alternative for closing the valve, whether applied in parenteral bags or in vials of medicines, vaccines or related.

### DESCRIPTION OF DRAWINGS

he valve with on-off mechanism for bag used for packaging, reconstitution and/or dilution of products for injectable use, object of this Continuation In Part—CIP, is represented, in its entirety, through the drawings listed in follow where:

FIG. 1 shows a perspective view of the valve with an on-off mechanism for a bag used for packaging, reconstitution and/or dilution of products for injectable use, as deposited in the main document;

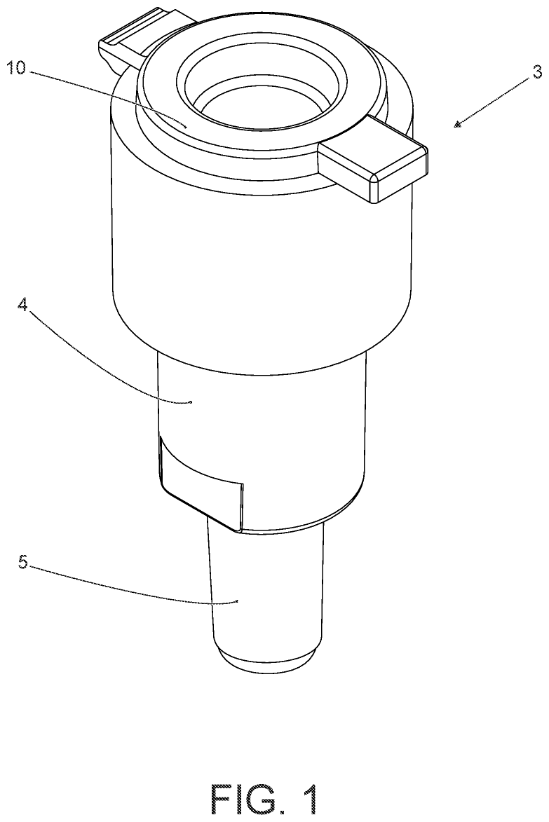

FIG. 2 shows a perspective view of the valve with an on-off mechanism for a bag used for packaging, reconstitution and/or dilution of products for injectable use, illustrating (in broken lines, the narrowing to be removed from the base conical, resetting the valve for use in vials;

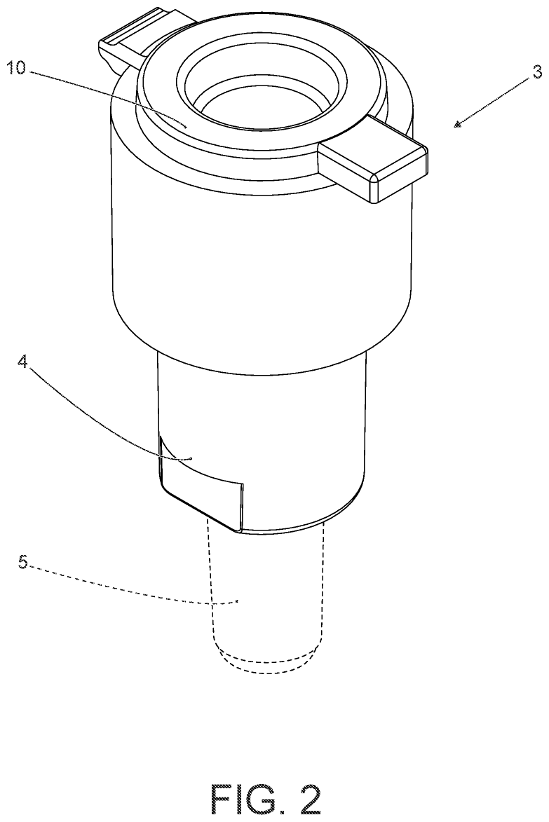

FIG. 3 shows a perspective view of the constructive variant of the valve with on-off mechanism for a bag used for packaging, reconstitution and/or dilution of products for injectable use, without the narrowing and with the appropriate conical base to the diameter of the vial nozzle resetting the valve for use in vials;

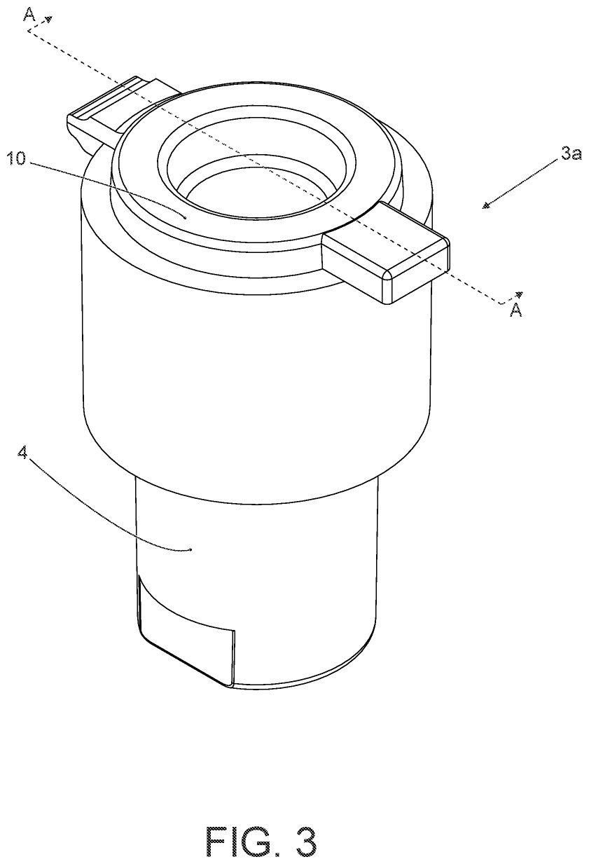

FIG. 4 shows a sectional view of the model of the valve variant with on-off mechanism for a bag used for packaging, reconstitution and/or dilution of injectable products, for use in vials of medicines, vaccines and the like, cut this indicated by the cut line “A”-“A” in FIG. 3;

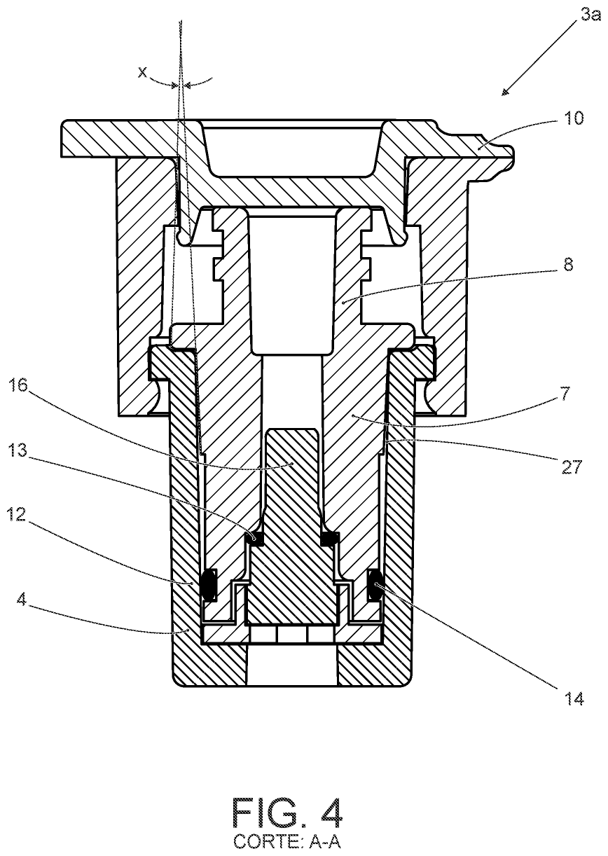

FIG. 5 shows an exploded perspective view of the variant of the valve with on-off mechanism for a bag used for packaging, reconstitution and/or dilution of injectable products, being applied in a generic model of a vial representative of vials of medicines, vaccines and related;

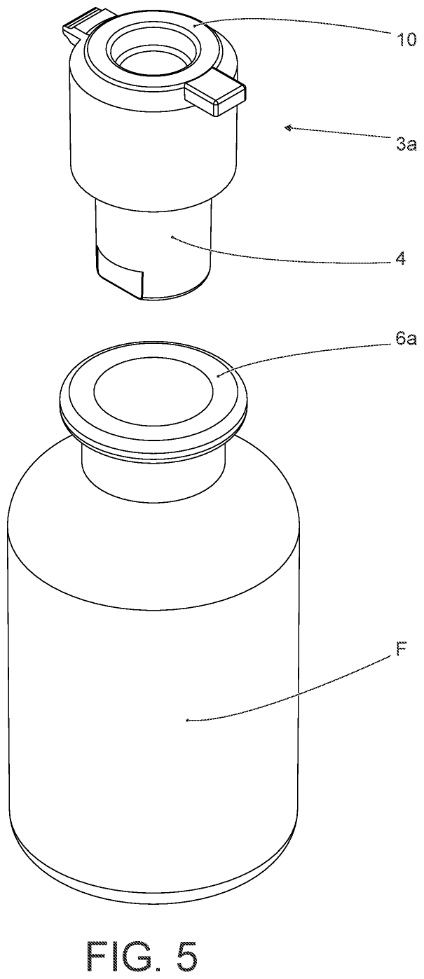

FIG. 6 shows an assembled perspective view with the lid closed, of the valve variant with on-off mechanism for bag used for packaging, reconstitution and/or dilution of products for injectable use, already applied in a model of representative bottle of bottles of medicines, vaccines and related;

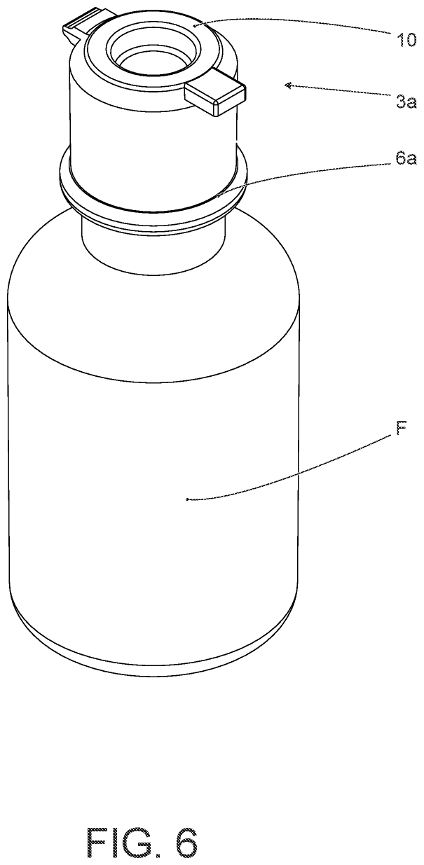

FIG. 7 shows an assembled perspective view, with the lid open, of the valve variant with on-off mechanism for bag used for packaging, reconstitution and/or dilution of products for injectable use, applied in a bottle model representative of medicines, vaccines and related;

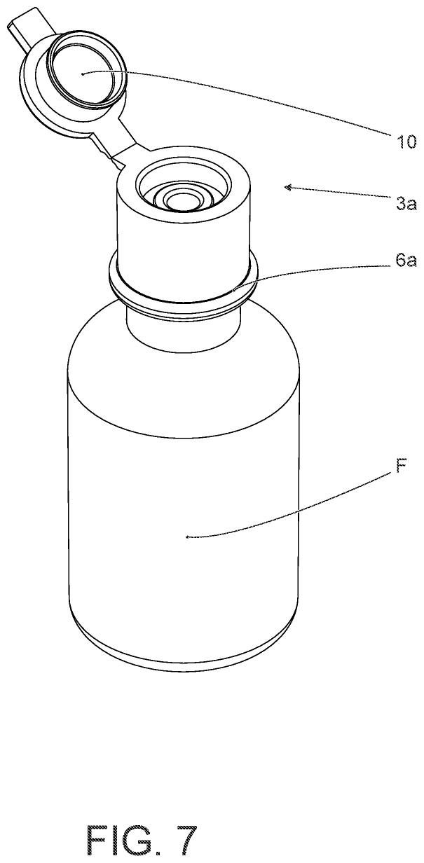

FIG. 8 shows a side view of the bottle with the valve cap open and the syringe with luer-lock pattern thread positioned to transfer the drug;

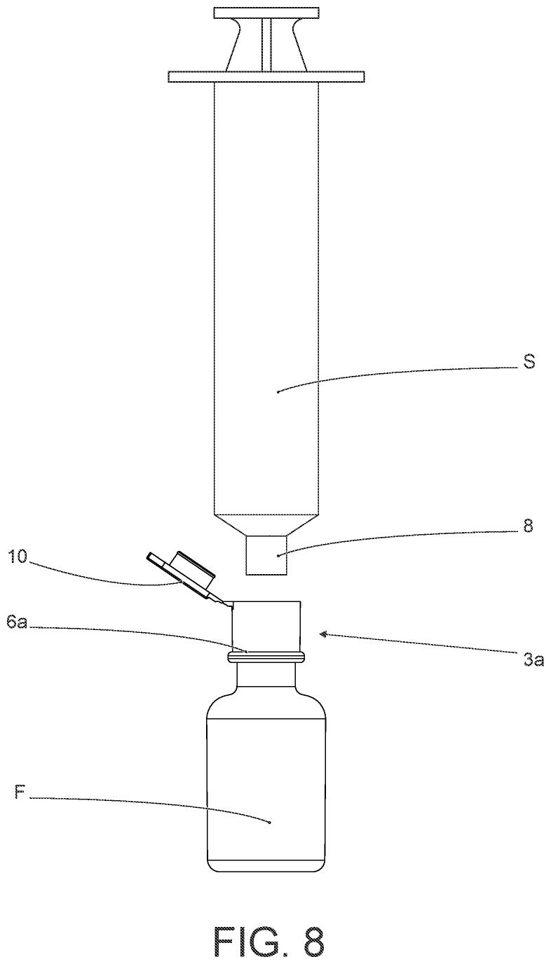

FIG. 9 shows a side view of the vial with the valve cap open and the syringe with luer-lock pattern thread already fitted to the vial valve;

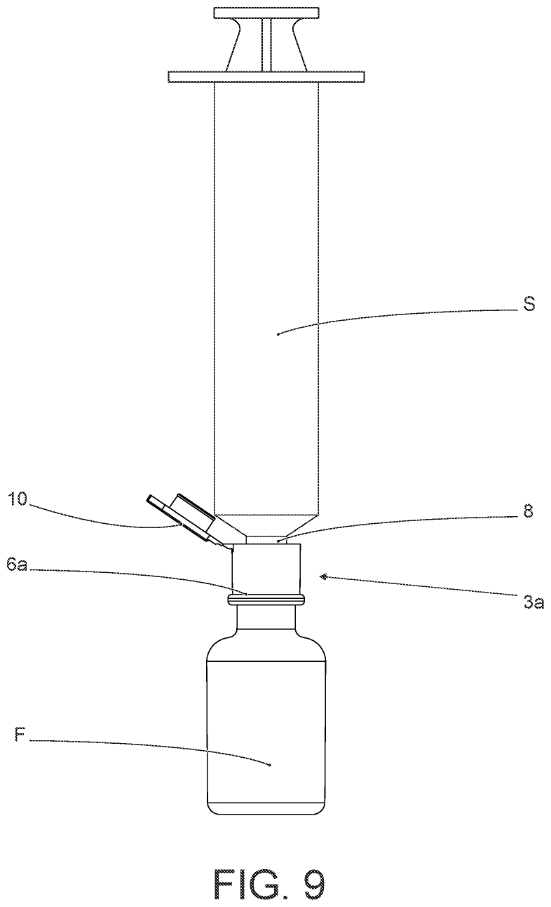

FIG. 10 shows a perspective view of the valve model with on-off mechanism for a bag used for packaging, reconstitution and/or dilution of injectable products, for use in a generic model of a representative bottle of plastic bottles of agrochemicals;

FIG. 11 shows a perspective view of the access system to the content of conventional bottles with an on-off mechanism valve;

FIG. 12 shows a perspective view of a dilution and drip chamber with the valve model usable in vials provided for in this document;

FIG. 13 shows a perspective view of a conventional vial and a syringe with a needle, at the time of transfer of the drug or vaccine, for application to the patient, through a syringe;

FIG. 14 shows a traditional bottle with a constructive variation for the valve cap.

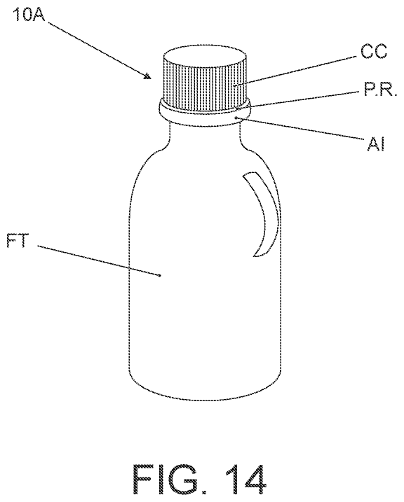

### REFERENCE SIGNS

The valve with on-off mechanism for bag used for packaging, reconstitution and/or dilution of products for injectable use, will be better described, through the reference signs below:
(3) valve shown in the original document;
(3a) valve variant;
(4) conical base;
(5) narrowing shown on the valve of the original document;
(6a) mouth of the bottle;
(7) movable conical part;
(8) standard luer-lock thread;
(10) cover;
(10a) alternative cover construction;
(12) larger diameter o'ring ring;
(13) smaller diameter o'ring ring;
(14) lower groove;
(16) core;
(22) surface;
(27) inner surface;
(AI) lower ring;
(CA) dilution and drip chamber
(CC) cylindrical body of the cover;
(F) bottle;
(FA) agrochemical flask;
(FT) traditional bottles;
(PR) breakpoints;
(S) syringe; and
(x) angulation.

### DETAILED DESCRIPTION OF THE INVENTION

The valve (3) with on-off mechanism for bag used for packaging, reconstitution and/or dilution of products for injectable use, object of this CIP, Continuation-in-part, is usable in transfers, dilution chamber and drip and vials for medicines, vaccines and the like, and the valve (3) is characterized by having five basic components, the first being the conical base (4), which receives inside the assembly of the second component that it is the conical movable part (7); the conical base (4) receives in its core (16) the assembly of the third component which is a smaller diameter o-ring sealing ring (13); on the other hand, the conical movable part (7) receives in its lower groove (14) the assembly of the fourth component, which is a larger diameter o-ring sealing ring (12); the conical base (4) receives the assembly of the fifth component which is the cover (10); the cover (10) also prevents the moving conical part (7) from separating from the conical base (4); the movable conical part (7) has a surface (22) with angulation (X), which angulation is the same as that found on the inner surface (27) of the conical base (4).

In the main patent document, the valve (3) presents a narrowing defined by a tubular terminal, provided for in the conical base. The constructive variation of this valve (3), defined as valve (3a), is fixed to the mouthpiece (6a) of the bottle (F) through its conical base (4), instead of being fixed to the tube (6) of the bag (1) (these last two items, not illustrated).

For the use of the valve (3a) in place of the rubber stoppers previously provided for in the medicine bottles, structurally the valve (3a) remains the same, if compared to the valve (3) presented in the original document, only the base conical (4) is adjusted to the diameter of the flask, eliminating only the narrowing (5) of said conical base (4), which originally, is used in the connection with the tube (6) of plastic bag (1) (these two last items not illustrated) however, the valve system does not change.

In addition, the cap (10) of the valve (3a) can present a constructive variation (10a) to adapt more easily to the bottle closing machine, and, also, in this case, the change of the cap structure does not change the valve system.

The constructive variant of the cover (10a) can be formed by a cylindrical body CC, internally threaded, provided with a lower ring (AI) connected to the cover body through a plurality of breaking points (PR), soldering points plastic or shrink, however, also in this case, the valve mechanism in question remains unchanged, keeping the same components: two conical plastic parts (4) and (7) that fit together and two rubber sealing rings of the type o′ring, one with larger diameter (12) and one with smaller diameter (13).

Many products existing in the pharmaceutical industry are likely to be composed by the valve closing system, benefiting from its functions in different market segments (human, animal, vegetable), particularly products that require health care.

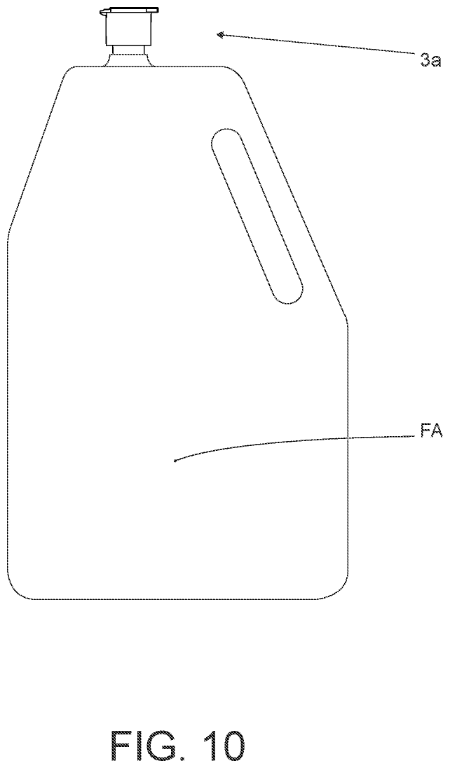

An example within these different market segments are the bottles with agrochemicals (FA) (illustrated in FIG. 10), which can improve the safety of use by adopting the valve system as a lid, with access to the content being made by connection with syringe (S) or other device with standard luer-lock thread (8).

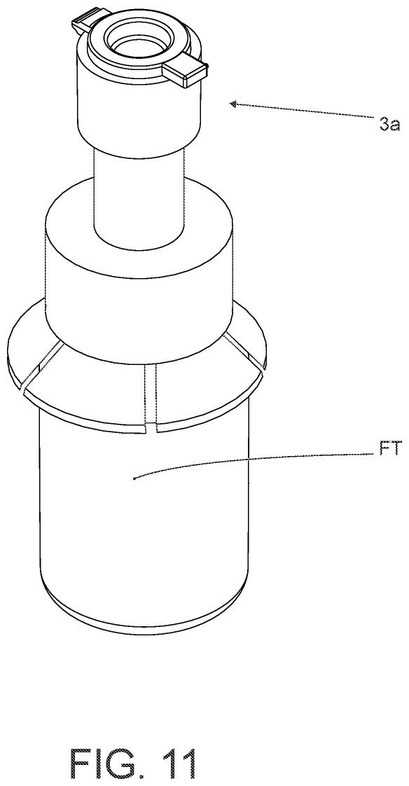

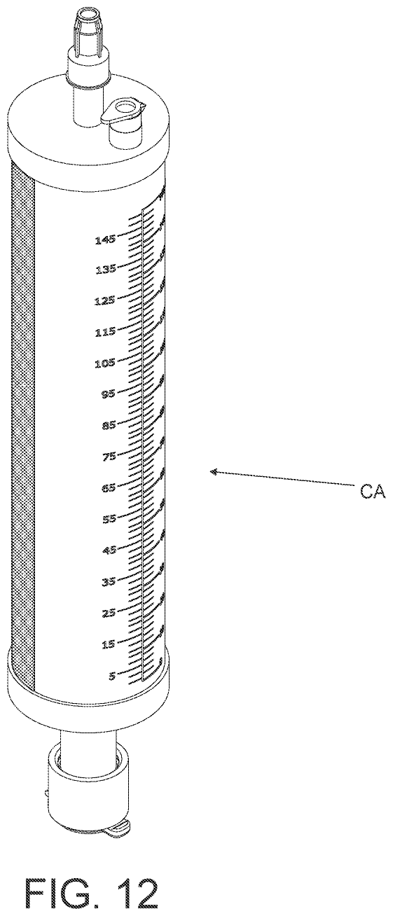

To demonstrate the breadth of use of the valve closing system, taking as examples only products that require sanitary care, it can be seen that the valve lends itself to different products, such as in transfers (FIG. 11) to access the content of traditional vials (FT) or in new medical devices such as dilution and drip chambers (CA) (FIG. 12), to replace traditional burettes.

With the valve (3a), object of this order, the preparation processes of the products, particularly the powders for injection, the subdivisions of doses will be substantially facilitated and the packaging of the products will be revolutionized.

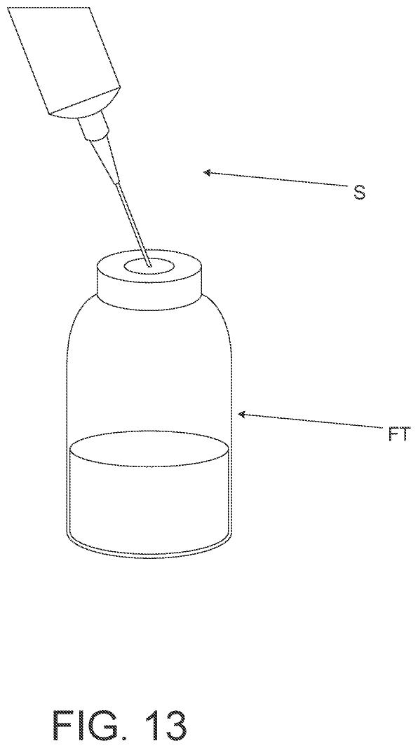

A product now considered a single dose, can be subdivided in hospital pharmacies, which are equipped with laminar flow, safely, without perforations of rubber stoppers (FIG. 13); in the case of BULK presentations, containing several individual doses, access to these larger bottles will be greatly facilitated and the subdivisions of doses will also be equally safe.

1. “VALVE WITH ON-OFF MECHANISM FOR BAG USED FOR CONDITIONING, RECOSTITUTING AND/OR DILUTION OF INJECTABLE PRODUCTS”, presents a valve (3) wherein have five basic components, the first being a conical base (4), which receives inside an assembly of the second component, which is a conical movable part (7); a conical base (4) receives in its core (16) an assembly of the third component which is a sealing ring of the type or smaller diameter ring (13); on the other hand, the conical movable part (7) receives in its lower groove (14) the assembly of the fourth component, which is a larger diameter o-ring sealing ring (12); a conical base (4) receives an assembly of the fifth component which is a cap (10), which protects a thread in the luer-lock pattern (8); the cover (10) also prevents the moving conical part (7) from separating from the conical base (4); a conical movable part (7) has a surface (22) with an angulation (X), equal to that verified on the inner surface (27) of the conical base (4); the constructive variation of the valve (3) defined as valve (3a), is fixed to the mouthpiece (6a) of the bottle (F) through its conical base (4), this adjusted to the diameter of the bottle, keeping the valve system unchanged.

2. “VALVE WITH ON-OFF MECHANISM FOR BAG USED FOR CONDITIONING, RECOSTITUTING AND/OR DILUTION OF INJECTABLE PRODUCTS”, according to claim 1, whereom in that it has a lid (10a) in a constructive variation being formed by a cylindrical body (CC), internally threaded, provided with a lower ring (AI) connected to the body (CC) of the lid (10a) through of a plurality of rupture points (PR), plastic or shrink welding points, however, also in this case, the valve mechanism in question remains unchanged, keeping the same components: two conical plastic parts (4) and (7) which fit between each other and two o-ring type rubber seal rings, one with a larger diameter (12) and one with a smaller diameter (13).

3. “VALVE WITH ON-OFF MECHANISM FOR BAG USED FOR CONDITIONING, RECOSTITUTING AND/OR DILUTION OF INJECTABLE PRODUCTS”, according to claim 1, wherein that it is used in bottles with agrochemicals (FA), with access to the content being made by connection with a syringe (S) or other device with thread in the luer-lock pattern (8).

4. “VALVE WITH ON-OFF MECHANISM FOR BAG USED FOR CONDITIONING, RECOSTITUTING AND/OR DILUTION OF INJECTABLE PRODUCTS”, according to claim 1, Wherein that it is used in transfers (FIG. 11) to access the content of traditional bottles (FT).

5. “VALVE WITH ON-OFF MECHANISM FOR BAG USED FOR CONDITIONING, RECOSTITUTING AND/OR DILUTION OF INJECTABLE PRODUCTS”, according to claim 1, wherein that it is used in medical devices such as dilution and drip chambers (CA) (FIG. 12), replacing traditional burettes.
